(19) United States
(12) Patent Application Publication
(10) Pub. No.: US 2007/0295545 A1
(43) Pub. Date: Dec. 27, 2007

(54) Differential Steering and Traction Control For Electrically Propelled Mower

(76) Inventors: Bernard Edwin Romig, Illinois City, IL (US); Jitendra Vaidya, Fargo, ND (US); Brent Gordon Rinholm, Fuquay Varina, NC (US); Randall J. Griffin, Irwin, NC (US); Russell J. Thacher, Monroe, NC (US)

Correspondence Address: DEERE & COMPANY, ONE JOHN DEERE PLACE, MOLINE, IL, 61265, US

(21) Appl. No.: 11/747,353

(22) Filed: May 11, 2007

Related U.S. Application Data
(60) Provisional application No. 60/799,699, filed on May 11, 2006.

(51) Int. Cl. B60K 28/16; B62D 6/00; G06F 7/00

(52) U.S. Cl. 180/197; 180/6.2; 701/41; 701/69

(57) ABSTRACT

A differential steering and traction control system for an electrically propelled mower. Each of the front wheels has an electric motor wheel drive, and each rear wheel may have an electric steering motor. The operator's station has a steering wheel and a speed control. An electronic controller provides steering commands to the electric steering motor and separate speed commands to each electric motor wheel drive based on the angle of the rear wheel and the position of the speed control.

This Non-Provisional patent application claims priority based on prior filed U.S. Provisional patent application Ser. No. 60/799,699, filed May 11, 2006, entitled DIFFERENTIAL STEERING AND TRACTION CONTROL FOR ELECTRICALLY PROPELLED MOWER, under 35 USC 119(e).

### TECHNICAL FIELD OF THE INVENTION

The invention relates to steering and traction control for electrically propelled vehicles, and particularly to differential steering and traction control systems for electrically propelled mowers.

### BACKGROUND OF THE INVENTION

Conventional riding mowing machines such as greens mowers, fairway mowers, and other wide-area mowers are used to mow grass on golf courses, athletic fields, and other areas that require high quality mowing. These mowers are steered solely by changing the angle of the rear wheel or wheels. The operator's steering wheel is mechanically or hydraulically connected to the rear wheel steering geometry.

The two front wheels on conventional riding mowing machines provide all, or the majority of, the vehicle's wheel torque. During turns, the torque of each powered wheel, either the left or right wheel, is passively adjusted so that the outside wheel turns faster than the inside wheel, in a ratio approximately proportional to the angle of the steered rear wheel. This method is relatively simple, but does not optimize traction. Additionally, if one of the powered wheels loses traction, all power from the propulsion drive of the riding mowing machine goes to the slipping wheel, and the machine may be stopped until traction returns.

A riding mowing machine is needed for golf courses, athletic fields, and similar applications that provides optimal traction. A riding mowing machine is needed that will continue to move even if one of the driven wheels loses traction.

Riding mowing machines with electric propulsion have been proposed. For example, U.S. Pat. No. 5,406,778 relates to an electric drive riding greens mower with a battery power source, an electric motor to provide driving torque, and electric motors for each of the cutting reel units.

### SUMMARY OF THE INVENTION

The invention provides a differential steering and traction control system for a riding mowing machine.

### BRIEF DESCRIPTION OF THE DRAWINGS

FIG. 1 is a side view of a riding mowing machine with a differential steering and traction control system of the present invention;

FIG. 2 is a schematic diagram of a differential steering and traction control system according to one embodiment of the present invention.

FIG. 3 is a schematic diagram of a differential steering algorithm in a differential steering and traction control system according to one embodiment of the present invention.

FIG. 4 is a schematic diagram of a wheel motor control algorithm for the torque and speed commands in a differential steering and traction control system according to one embodiment of the present invention.

FIG. 5 illustrates a computer algorithm for the differential steering and traction control system according to one embodiment of the invention.

FIG. 6 is a graph of motor speed ratios for the differential steering and traction control system according to one embodiment of the invention.

FIG. 7 is a schematic representation of a bevel gear implementation of a differential in which the output shafts are connected so that they share the torque equally.

FIG. 8 is a schematic representation of a bevel gear implementation of a torque-proportioning differential with a 2:1 torque ratio.

FIG. 9 is a schematic representation of a torque-proportioning differential system with three outlets, supplying one third of the input torque to each of three outlets.

FIG. 10 is a schematic representation of a Ferguson differential which limits the ratio of the two output speeds.

FIG. 11 is a block diagram of a control scheme according to one embodiment of the invention in which the operator inputs a speed command.

FIG. 12 is a block diagram of a control scheme according to a second embodiment of the invention in which sensor inputs for the accelerator position, steering position and wheel speed are sensed.

FIG. 13 is a data table of the steering rack deflection and drive wheel speed ratios of the differential steering and traction control system according to one embodiment of the invention.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

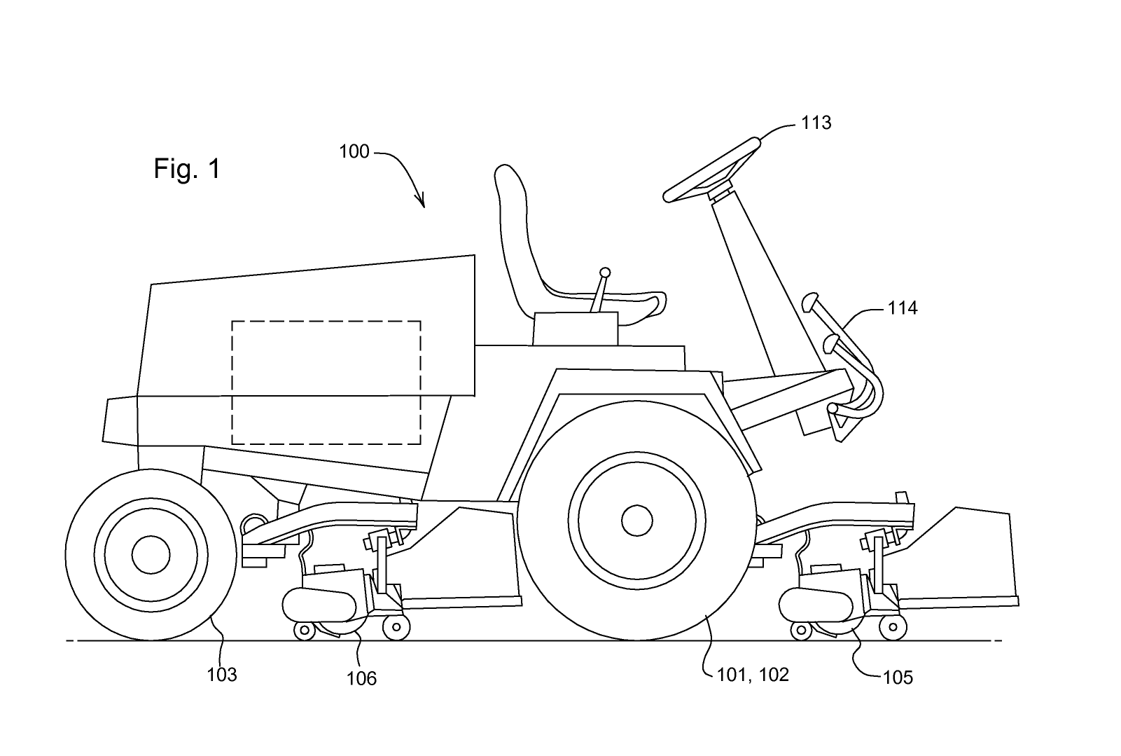

FIG. 1 illustrates one embodiment of a riding mowing machine 100 such as a triplex greens mower having electric motor wheel drives and a differential steering and traction control system. The differential steering and traction control system, however, is not limited to triplex greens mowers but may be used on other mowing machines having electric motor wheel drives.

In one embodiment, riding mowing machine 100 may have a frame supported by a pair of front wheels 101, 102, each wheel powered by an electric motor wheel drive, and a single rear wheel 103 which may have an electric steering motor and optionally may include an electric motor wheel drive. The riding mowing machine may carry or support a plurality of cutting units 105 in a first row, and one or more cutting units 106 in a second row. Each cutting unit may be a reel-type cutting unit with a generally horizontally aligned reel, each reel powered by an electric motor. Alternatively, each cutting unit may be a blade rotating on a vertical shaft and covered by a deck.

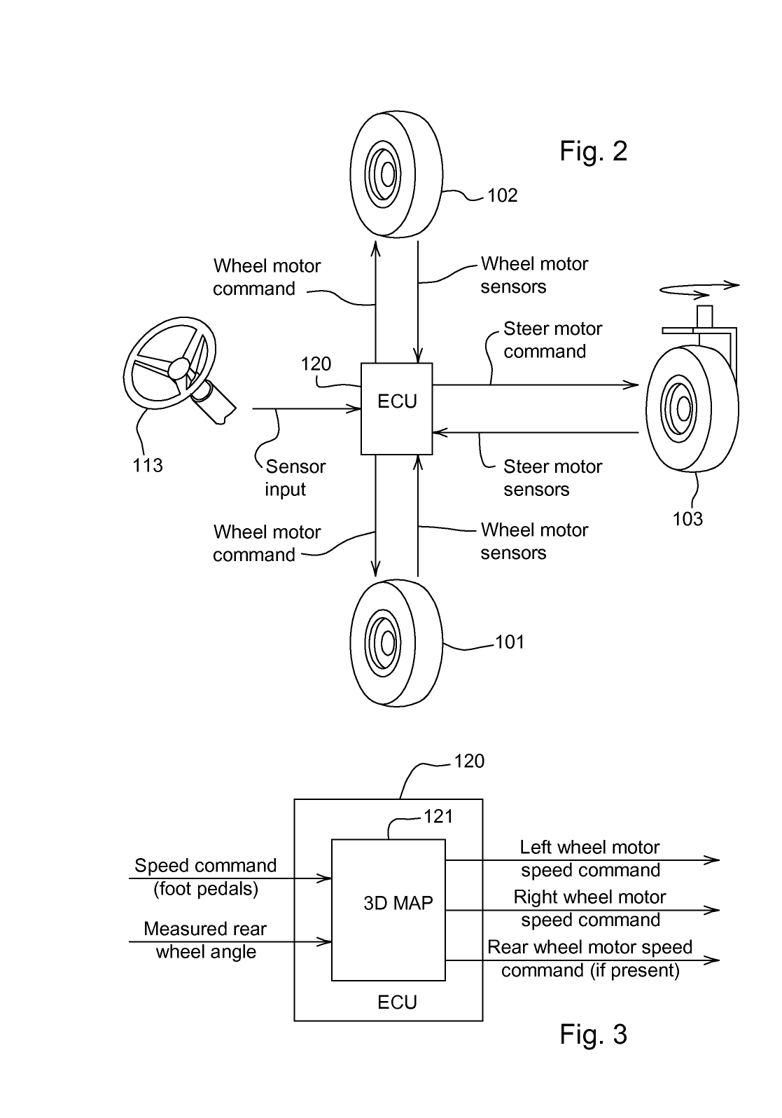

In one embodiment shown in FIG. 2, the differential steering and traction control system may include electronic control unit 120 that receives sensor input regarding the rotational position of steering wheel 113, speed information from wheel motor sensors for each of the electric motor wheel drives for left and right front wheels 101, 102, and the angular position of steered rear wheel 103 from a steer motor sensor. Based on the information from the sensors and other information concerning the vehicle, the electronic control unit then provides wheel motor commands to left and right wheel electric motor wheel drives and the rear wheel steer motor.

In one embodiment shown in FIG. 3, electronic control unit 120 may include a three dimensional map 121. The 3D map may be a table of numbers that were calculated based on geometry of the mowing machine. For example, the 3D map may indicate speed commands for each of the powered wheels based on information such as wheelbase, wheel track, and tire radius of the mowing machine, and widely used dynamics formulae. Based on the angle of steering wheel 113 and position of pedals 114, the electronic control unit can determine the appropriate left and right wheel motor speed commands by picking the two closest values in the 3D map and interpolating between them. The electronic control unit may continually read the foot pedal speed command and the actual rear wheel angle, and use the values in the 3D map to interpolate each wheel's new speed command. An example of a 3D map that may be used with a greens mower is shown in the figures.

Thus, electronic control unit 120 not only provides commands to an electric steer motor to turn rear wheel 103 in proportion to the steering wheel input, but also provides speed commands to the electric motor wheel drives to left and right wheels 101, 102 to continuously adjust their speed to remain in the correct proportion depending on the commanded speed and rear wheel angle.

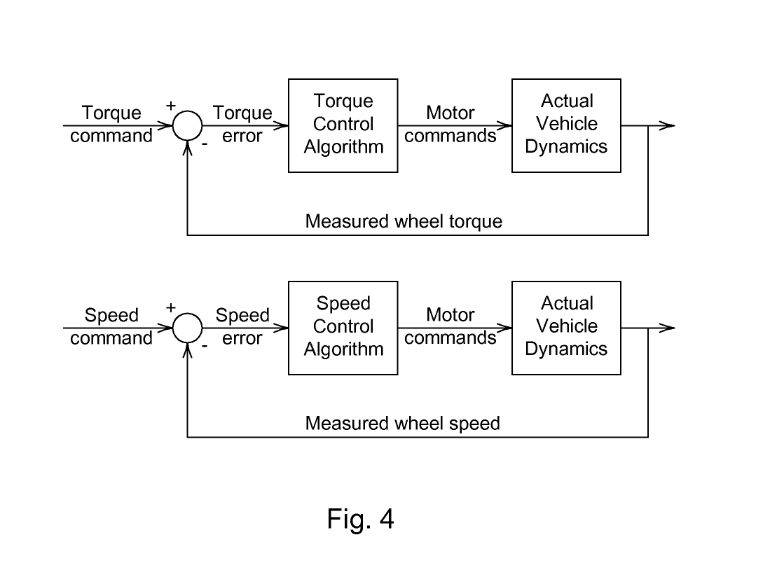

In one embodiment shown in FIG. 4, the speed and torque of each powered wheel 101, 102 may be electronically controlled by electronic control unit 120. Electronic control of the speed and torque of each powered wheel may act to prevent total loss of traction in straight-travel conditions. Speed and torque of each powered wheel may be controlled with a closed-loop algorithm in the electronic control unit. If one wheel loses traction, it will not affect the other wheel, and the vehicle will not slow or stop.

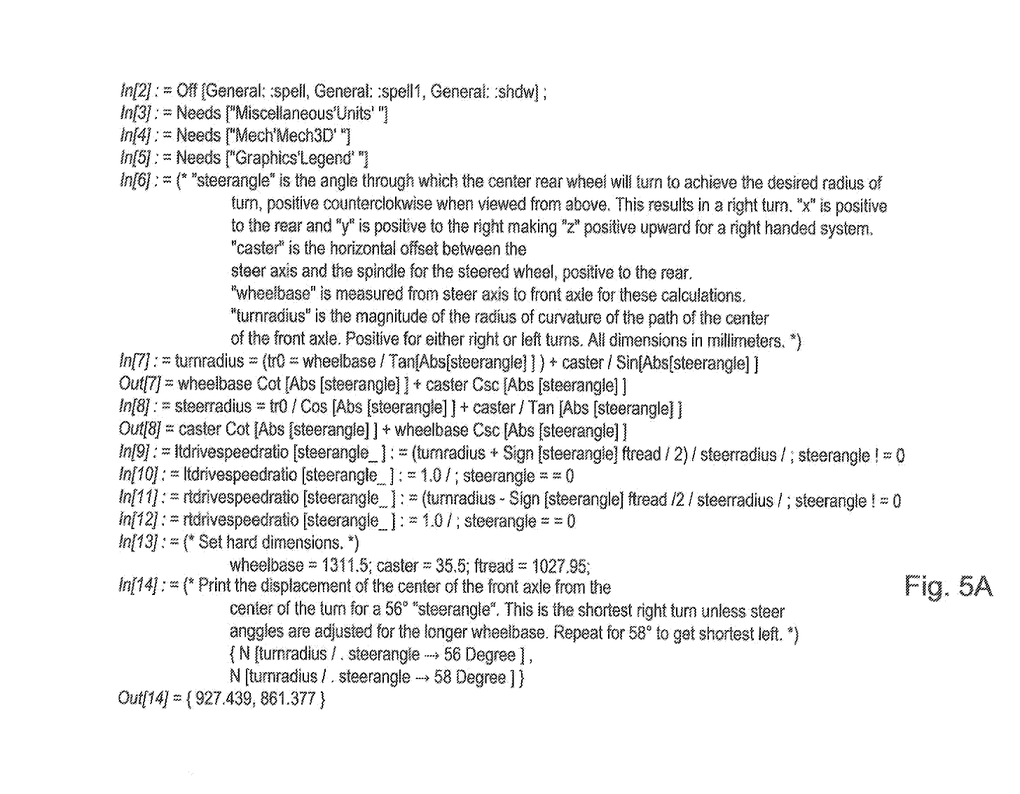

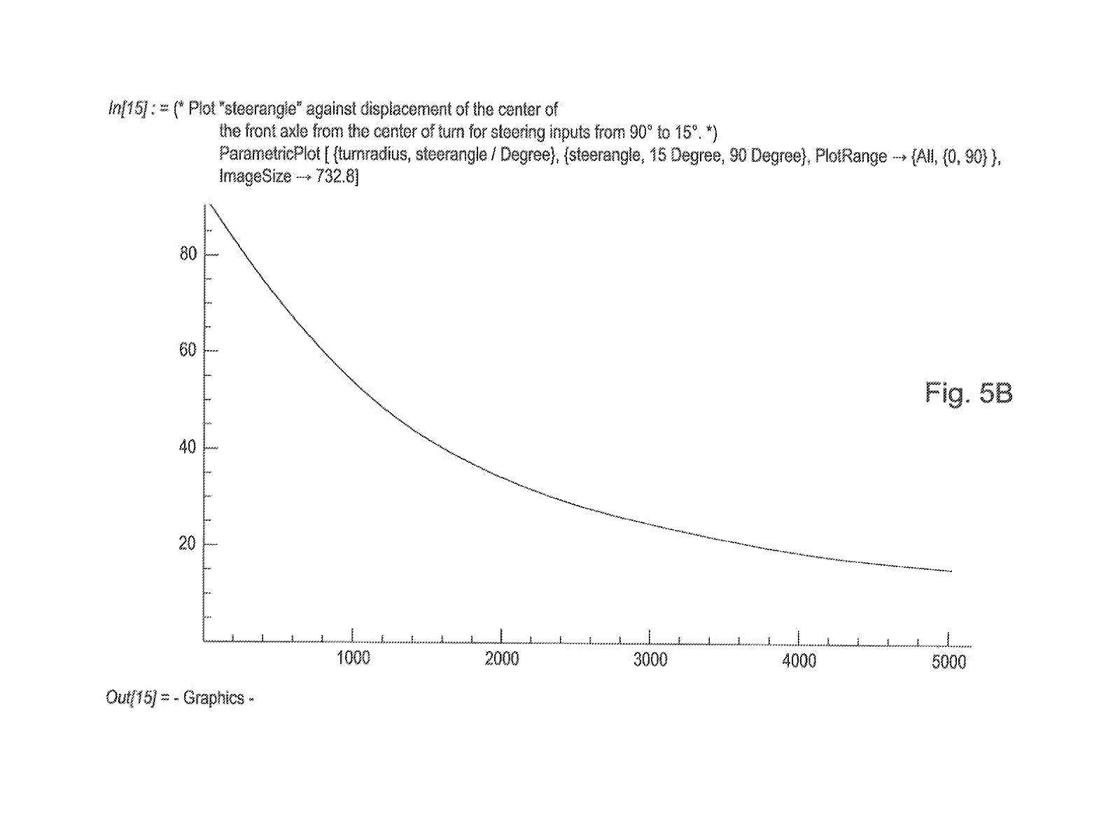

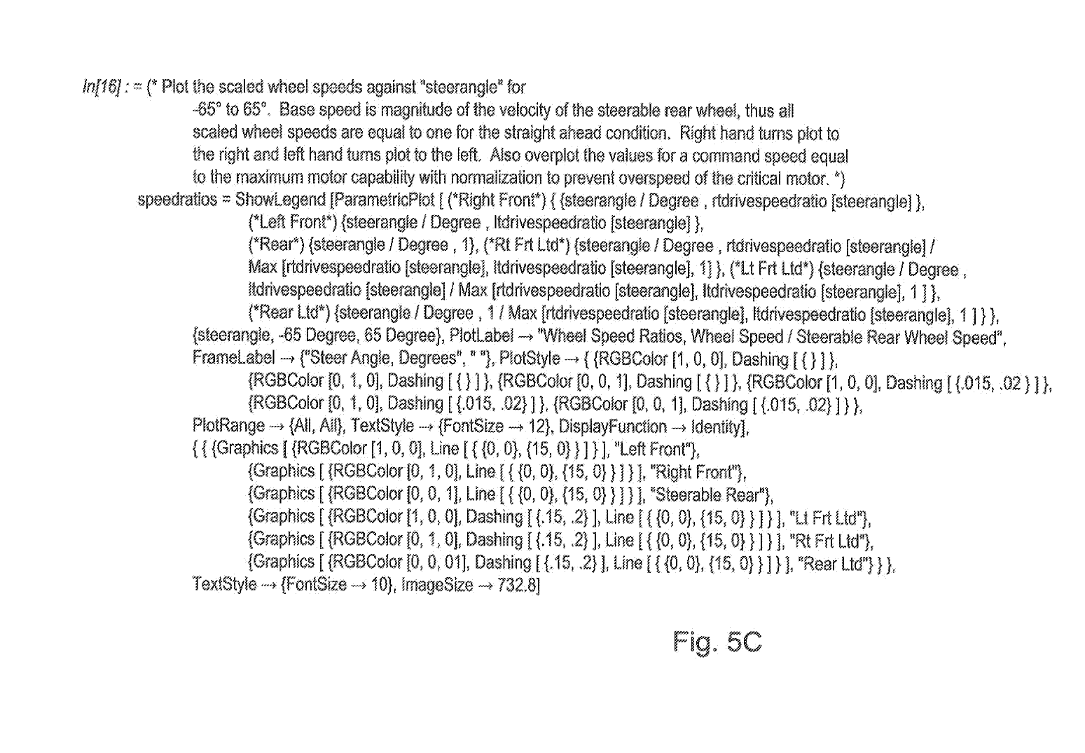

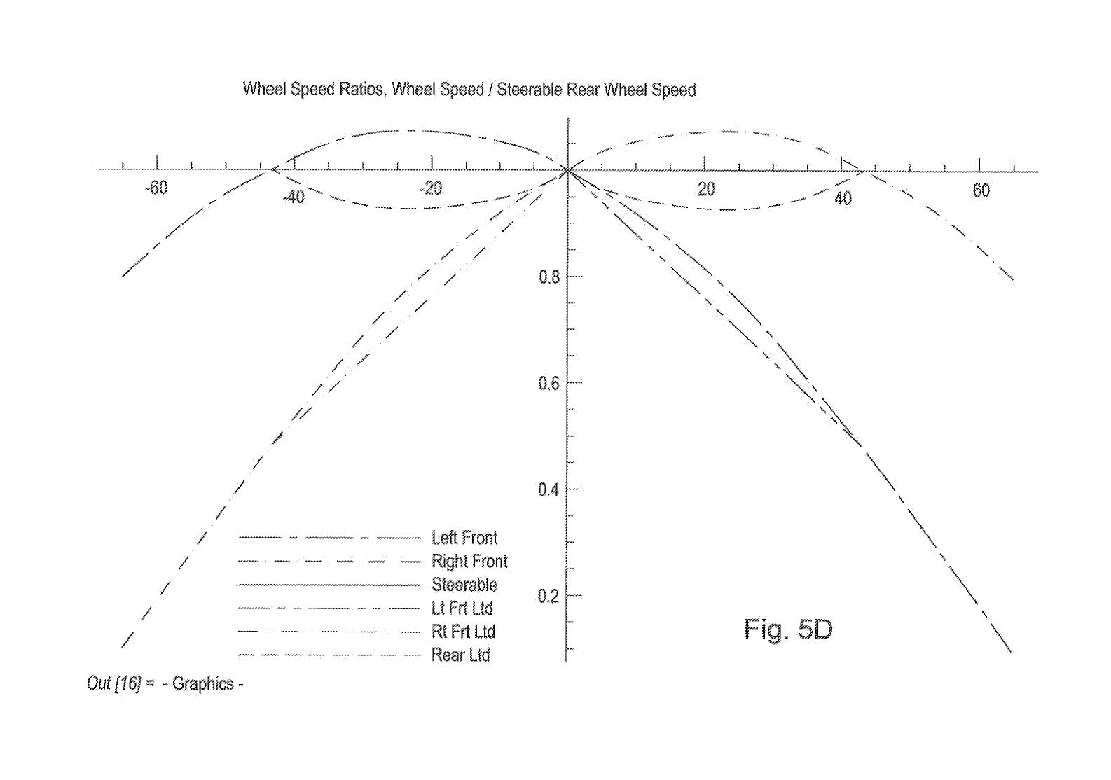

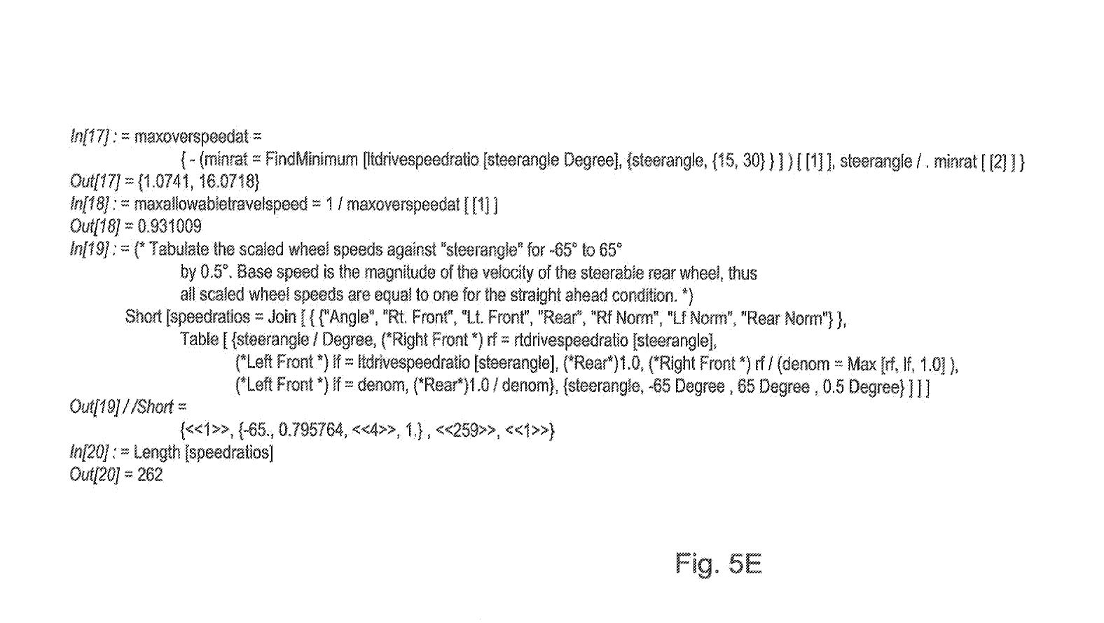

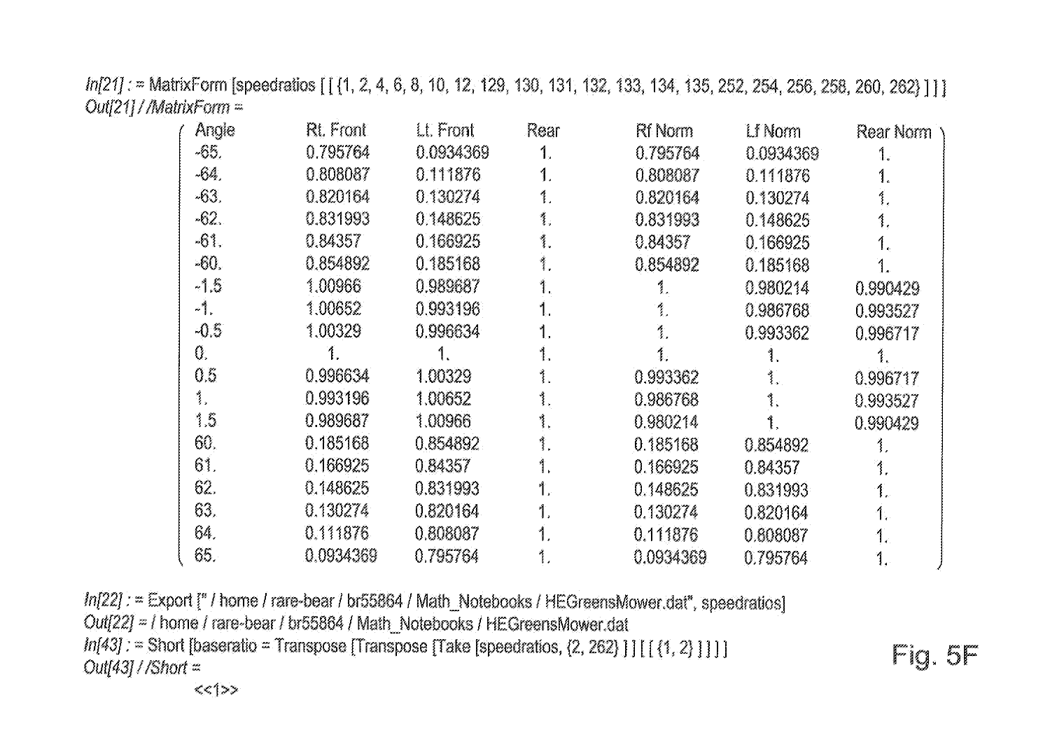

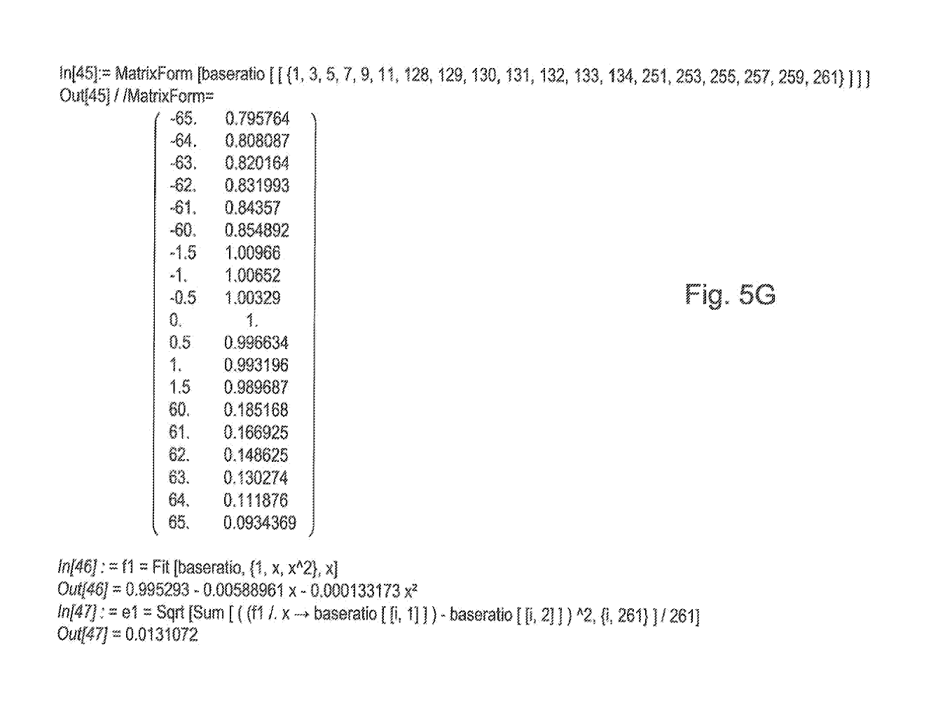

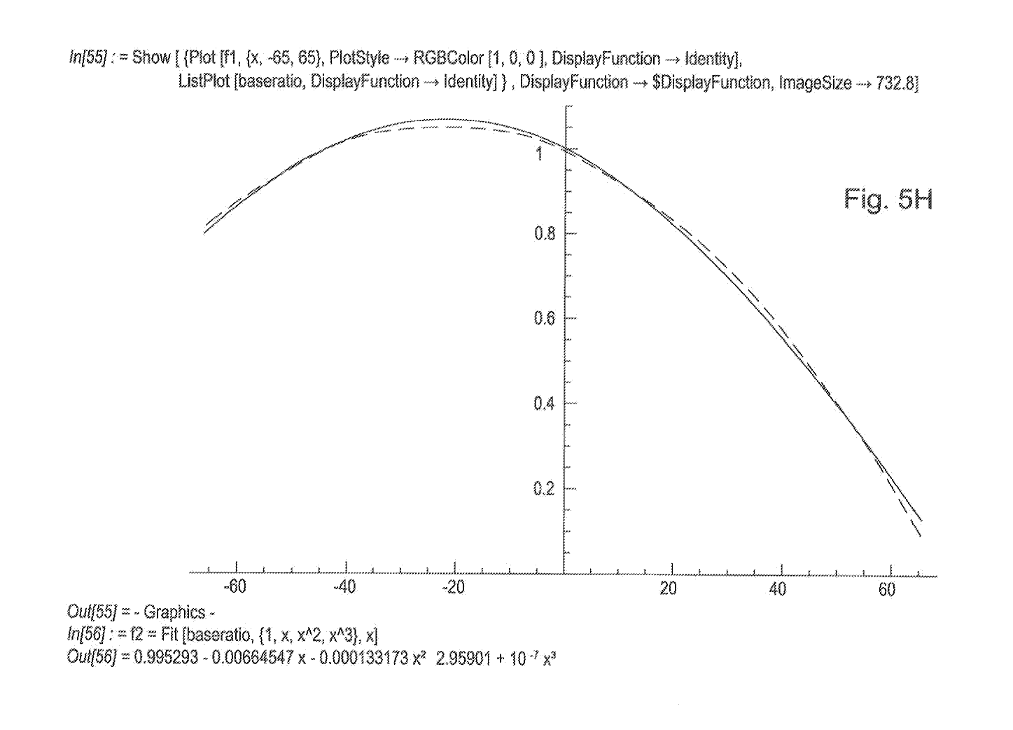

In the computer algorithm shown in FIG. 5, a speed command of 1.0 will cause the drive system to operate at a maximum speed in a forward direction, while a value of −1.0 will produce the same speed in the opposite direction. The vehicle may turn in a kinematic fashion without lateral or longitudinal slip at the wheels. A set of numbers may be generated based on these maximums and the dimensions of the mowing vehicle. To achieve kinematic turning, the magnitude of the velocity vector at almost any point on the vehicle chassis may be used as the base speed, and the magnitude of the velocity vector at any other point may be determined as a fixed ratio to this base speed. The ratio may depend only on the angle through which the steerable wheel is deflected. The point at which base speed is determined may be selected to avoid all possible instant centers of rotation. Any point on the vehicle centerline and not on the centerline of the non-steered axle may satisfy this requirement. Selecting the point at which the axis of the steerable wheel intersects the mid plane of the tire is preferred because the speed ratio for the drive on that wheel will always be 1.0.

In one embodiment, the mowing machine may not execute spin turns because the chassis of the mowing machine has 35.5 mm of caster in the steerable wheel mount. As a result, the turn radius at 90 degrees of steering deflection will be 35.5 mm, and a spin turn would require greater steering deflection.

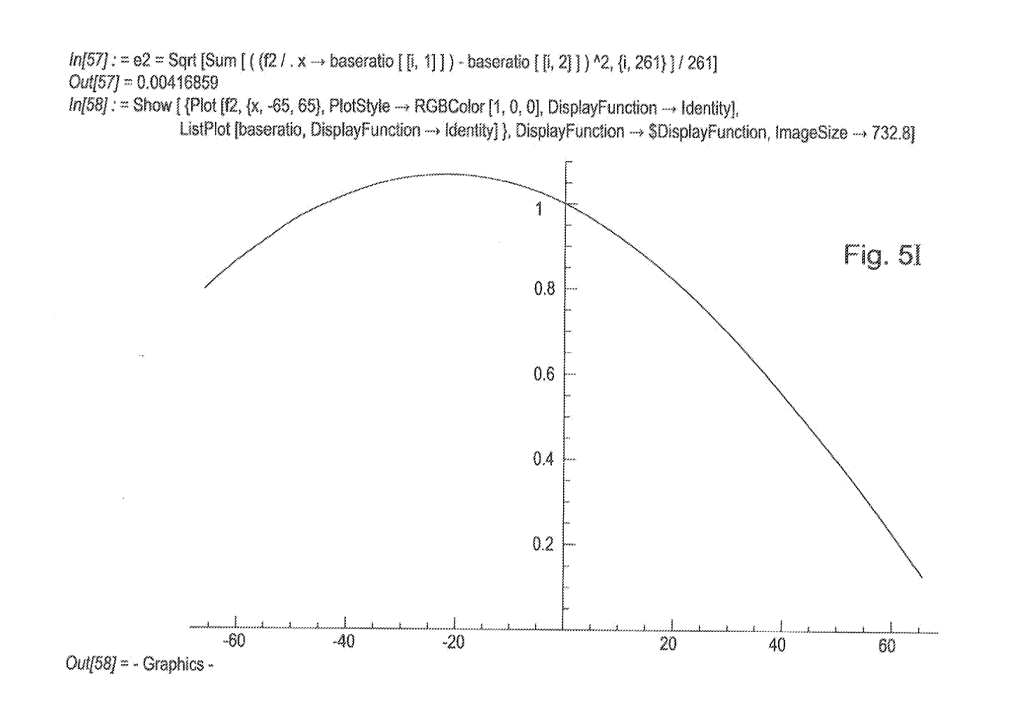

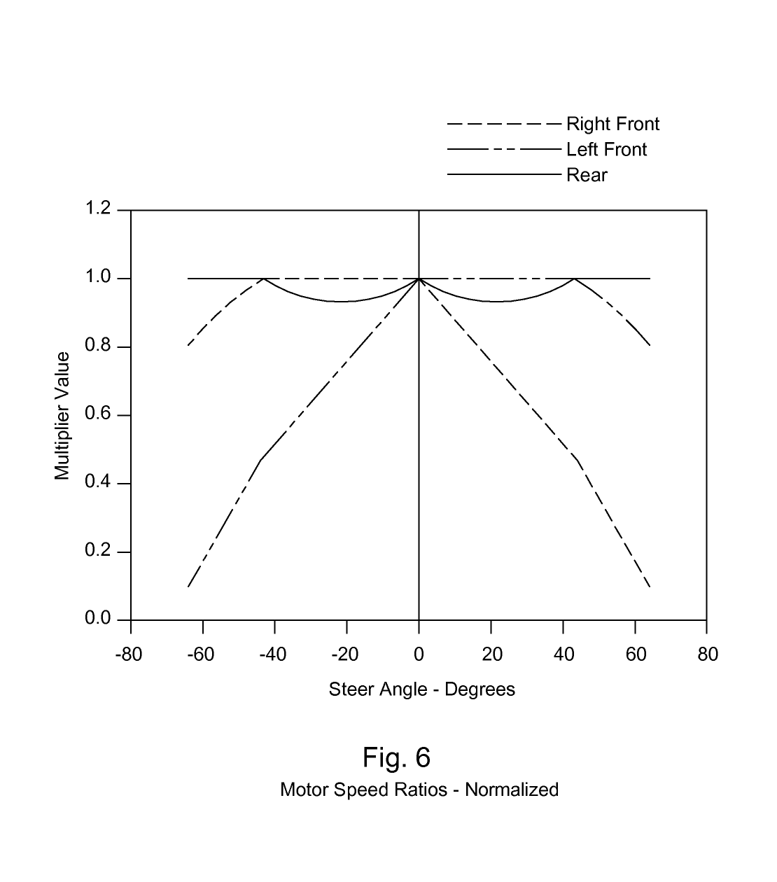

In one embodiment, the basic speed ratio curves may be functions of the steering angle, as shown in the curves plotted in FIG. 6. For example, for the dimensions of a typical greens mower chassis, the peak value may be 1.0741 at a steer angle of 16.0718 degrees. There are three alternatives to handle a peak value that exceeds 1.0. First, the magnitude of the vehicle speed command may be limited to 1/1.0741=0.931. This first option will limit the vehicle speed to a value lower than that imposed by the maximum motor speed. Second, the multipliers may be pre-normalized by dividing all three by the largest multiplier value encountered at that steer angle. This alternative may result in the mowing vehicle slowing down unnecessarily when performing gentle turns at less than maximum travel speed. The third alternative is for the controller to perform the normalization on the fly, which requires that each motor speed command may be computed for the current steering angle and vehicle speed command. Then, each motor speed command may be divided by the largest of the three vehicle speed commands and one. This makes the necessary correction if the vehicle speed command is between 0.931 and 1.0, and is the most preferred for performance and drivability of the mowing machine.

In one embodiment, the symmetry of the mowing machine chassis results in the front wheel speed ration curves being mirror images of each other, so only one look up table or fitted function is needed. The third alternative described above can be efficiently implemented because the critical wheel can be identified based on the sign of the steer angle. More specifically, the left front wheel is critical in right turns in which the steer angle is greater than or equal to zero, while the right wheel is critical for left turns. If the critical wheel has a speed command greater than 1.0, all wheel speed commands may be divided by the critical wheel's speed command. If not, the wheel speed commands may be divided by 1.0. In one embodiment, the straight ahead condition may be treated the same as right turns. Both front wheel speed ratios may be 1.0 if the steer angle is zero, so the only special handling needed is including the zero steer angle in the closed interval representing a right turn, and left turns can be represented by an open interval that excludes zero.

In one embodiment of the invention, a 360 degree one piece non-contact rotary position transducer may be used to determine the position of the steered wheel. For example, an RT600 Series sensor from Electro Corp. may be used.

In one embodiment, the kinematically correct wheel speed commands may be calculated for vehicles with independently controlled wheel motors when a suitable steering position sensor is used. The rolling radii for tires mounted on the powered wheels may not be known precisely, and it may be difficult to zero a steering sensor to the exact straight ahead position. In one embodiment, the present invention relates to a methodology which is tolerant of minor variations in sensing the wheel angle, while also providing performance advantages of having the wheel motor speeds coordinated with steering inputs.

In one embodiment, a mechanical system with torque proportioning differentials may be emulated until deteriorating tractive conditions allow one or more wheels to spin out. When the spin out condition is approached, the control logic may limit the torque to the low traction wheels as necessary to maintain the kinematically correct speed ratios for the current steer angle. The torque limitation may be calculated to mimic the performance of a traction control system using automatically actuated wheel brakes, but there is not dissipation involved, merely modifications to the torque commands going to the wheel motors.

In a conventional differential, the output shafts are connected so that they share the torque equally. Such a system is represented in equation form as:

$${T}_{1} = {T}_{2}$$

$${T}_{in} = {T}_{1} + {T}_{2}$$

$${ω}_{in} = \frac{{ω}_{1} + {ω}_{2}}{2}$$

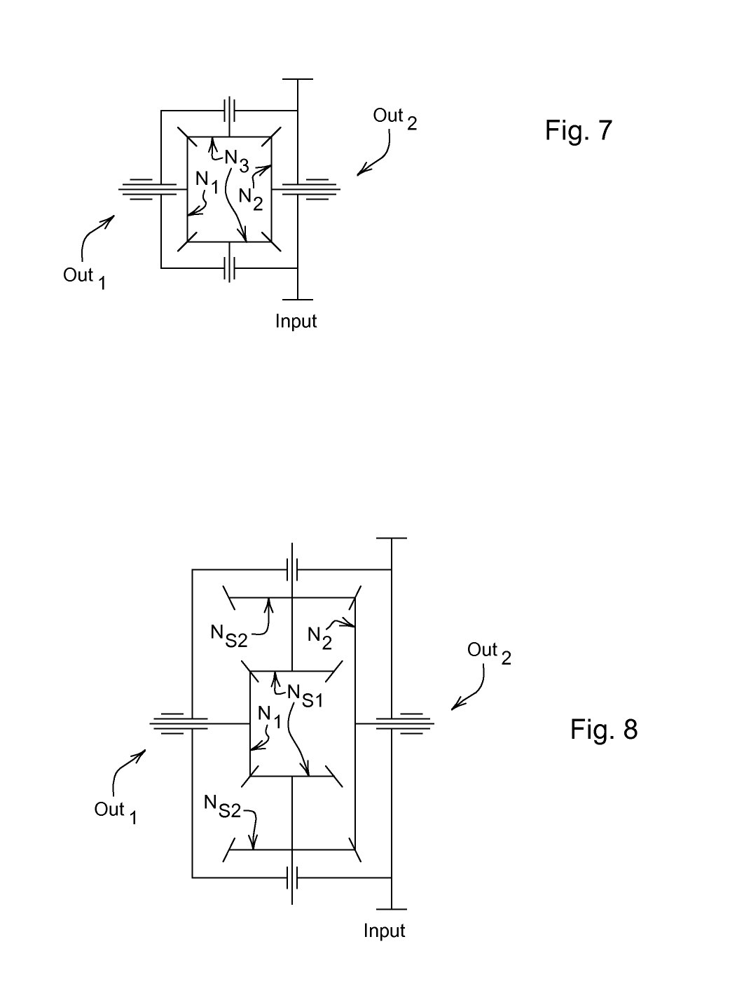

A bevel gear implementation is shown schematically in FIG. 7.
In a torque-proportioning differential, the output shafts are connected so that the torque on output one is a fixed multiple of the torque on output two. Such a system is represented in equation form as:

$$\begin{matrix}{T}_{1} = k {T}_{2} \\ {T}_{in} = {T}_{1} + {T}_{2} \\ {ω}_{in} = \frac{k {ω}_{1} + {ω}_{2}}{k + 1}\end{matrix}$$

or; equivalently:
Tᵢ=R₁Tᵢₙ
T₂=R₂Tᵢₙ
ωᵢₙ=R₁ω₁+R₂ω₂
R₁+R₂=1
If R₁=R₂=0.5, the second form represents a conventional differential. A bevel gear implementation of a torque-proportioning differential with a 2:1 torque ratio is shown schematically in FIG. 8.

$$\frac{{ω}_{1 c}}{{ω}_{S 1 c}} = \frac{{N}_{S 1}}{{N}_{1}}$$

$${ω}_{S 2 c} = {ω}_{S 1 c}$$

$$\frac{{ω}_{2 c}}{{ω}_{S 2 c}} = \frac{{N}_{S 2}}{{N}_{2}}$$

With:
N₁=N_{S1}
and
N₂=2N_{S2}
giving
R₁=⅓
and
R₂=⅔
In one embodiment, torque proportioning differential systems with multiple outlets, can be assembled by connecting two or more differentials in series. When this is done the system is represented by these equations:

$${T}_{1} = {R}_{1} {T}_{in}$$

$$\begin{matrix}{T}_{2} = {R}_{2} {T}_{in} \\ …\end{matrix}$$

$${T}_{n} = {R}_{n} {T}_{in}$$

$${ω}_{in} = {\sum }_{i = 1}^{n} {R}_{i} {ω}_{i}$$

$${\sum }_{i = 1}^{n} {R}_{i} - 1$$

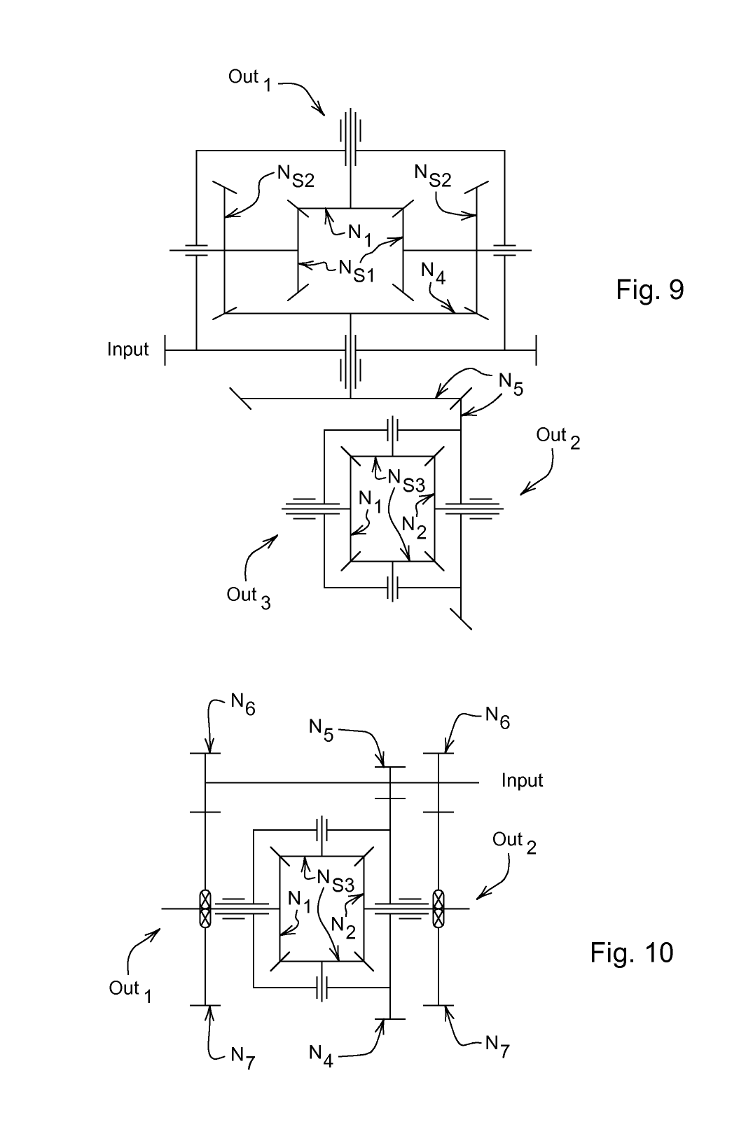

A three-outlet system supplying ⅓ of the input torque to each outlet is shown in the schematic of FIG. 9. The top differential supplies ⅓ of the input torque to outlet one and ⅔ to the input of the lower unit, which splits this torque equally between outlets two and three, hence supplying ⅓ to each.

The traditional open differential system has usually been designed to supply each wheel with a torque proportional to its tractive capability. To a first approximation, this results in Rᵢ=Wᵢ/Wₜₒₜₐₗ.

Viscous damped differentials have been used in many applications. However, the transfer of torque from one outlet to the other is represented by a term of the form: ΔTᵢ=Cᵢ(ωᵢ−ω_{ref}). A C value that is too large will impede turning while one that is too low will sacrifice pulling ability in marginal tractive conditions. In one embodiment, the invention matches the value of C or ω_{ref} to the operating condition of a mowing vehicle at any moment.

The Ferguson differential, named for its inventor, Harry Ferguson, used an auxiliary gear train and overrunning clutches to limit the ratio of the two output speeds. This effectively allowed the unit to function as an open differential until the limit was reached after which both outputs maintained a fixed ratio to the input. A schematic of a Ferguson differential is shown in FIG. 10.

This concept could not be matched to a wide range of maneuvers since setting the limits wide enough to allow short radius turns allowed too large a speed differential when pulling straight ahead. The only successful application was as a center differential in an early all wheel drive automobile. The present invention eliminates this problem by adapting the limiting speed ratio to the vehicle's maneuvers.

Another alternative that has been used in passenger cars is the automated application of the service brakes to limit torque to any wheel that starts to spin out. This is not considered applicable to off road equipment since it dissipates the excess energy scheduled for the low traction wheel instead of recirculating it to help power the other wheels as the Ferguson does.

The hard limits imposed by a Ferguson differential would be difficult to emulate in a stable control system. The following controls are modeled on a traction control system using automatically applied brakes on each wheel. The brake control is based on a hypothetical mechanical system in which a viscous coupling is interposed between the control gear and the overrunning clutch of a Ferguson differential. This produces a rapid but smooth increase in braking torque once the free overspend limit is exceeded, but without the hard discontinuities of the Ferguson differential.

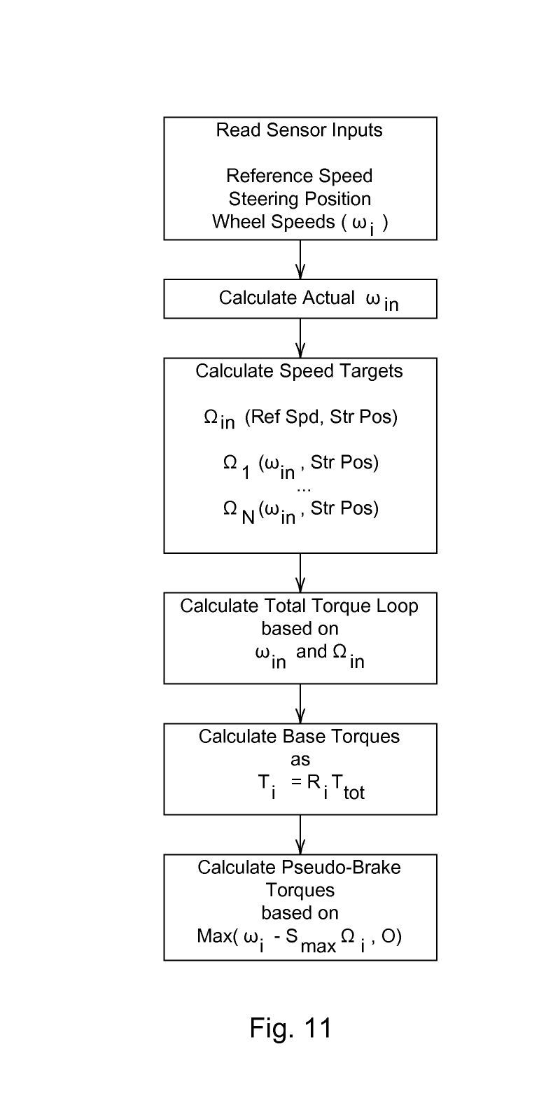

In one embodiment of the invention, two variants of a control scheme may be used. The first, which assumes that the operator inputs a speed command; is shown in block diagram form in FIG. 11. The first step in either control scheme is to read the steering position and calculate the kinematically correct, zero slip, wheel speed and the corresponding input speed to the differential system, Ωᵢₙ. These are all based on the steering configuration and the desired speed of the chassis reference point. The next step is to read all of the wheel speeds, compute the actual differential system input speed,

$${ω}_{in} = {\sum }_{i = 1}^{n} {R}_{i} {ω}_{i}$$

and compute the desired wheel speeds. In speed control mode the next step is to use the desired and actual differential system input speeds to calculate a base torque using any of the generally known closed loop speed control schemes. Base torque for each wheel is then established using the following relations:
T₁=R₁Tᵢₙ
T₂=R₂Tᵢₙ
. . .
Tₙ=RₙTᵢₙ
Pseudo-Brake torques are then calculated as follows:

$$\begin{matrix}{{T}^{⋒}}_{i} = 0 & \vert {{ω}^{⋒}}_{i} \vert + {ɛ}_{i} \geq {\vert ω \vert}_{i} \\ {{T}^{⋒}}_{i} = {C}_{i} ( \begin{matrix}{{ω}^{⋒}}_{i} + \\ {ɛ}_{i} Sign ( {{ω}^{⋒}}_{i} ) \\ - {ω}_{i}\end{matrix} ) & \vert {ω}_{i} \vert > \vert {{ω}^{⋒}}_{i} \vert + {ɛ}_{i}\end{matrix}$$

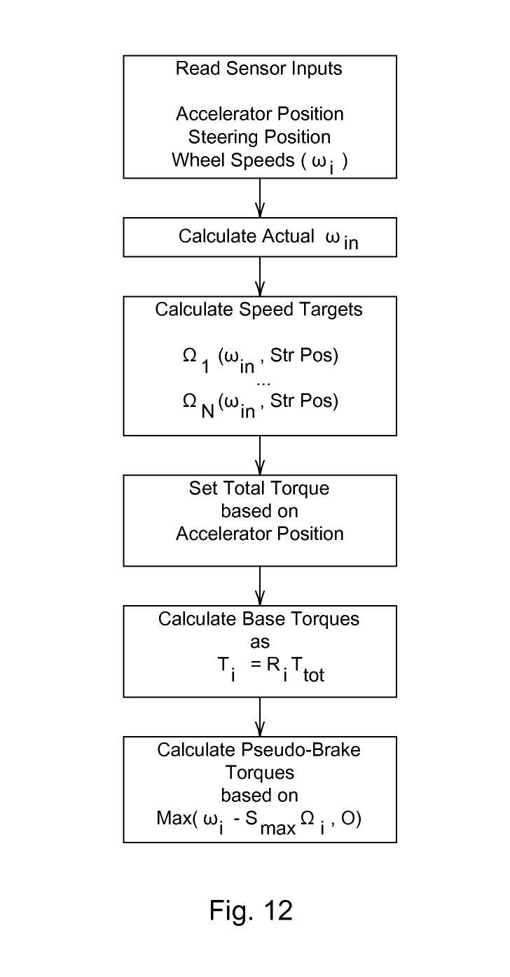

This is the second variant of the control scheme according to one embodiment of the invention, shown in block diagram form in FIG. 12. The first step is again, the reading of the steering position and the actual wheel speeds ωᵢ. The actual differential system input speed,

$${ω}_{in} = {\sum }_{i = 1}^{n} {R}_{i} {ω}_{i}$$

is then calculated.

The kinematically correct, zero slip, wheel speeds are then calculated, based on the steering configuration and the actual differential system input speed. The next step is to set a base torque using any accelerator pedal position to torque mapping needed to provide the desired control feel. Base torque for each wheel is then established using the following relations:
T₁=R₁Tᵢₙ
T₂=R₂Tᵢₙ
. . .
Tₙ=RₙTᵢₙ
Pseudo-Brake torques are then calculated as follows:

$$\begin{matrix}{{T}^{⋒}}_{i} = 0 & \vert {{ω}^{⋒}}_{i} \vert + {ɛ}_{i} \geq {\vert ω \vert}_{i} \\ {{T}^{⋒}}_{i} = {C}_{i} ( \begin{matrix}{{ω}^{⋒}}_{i} + \\ {ɛ}_{i} Sign ( {{ω}^{⋒}}_{i} ) \\ - {ω}_{i}\end{matrix} ) & \vert {ω}_{i} \vert > \vert {{ω}^{⋒}}_{i} \vert + {ɛ}_{i}\end{matrix}$$

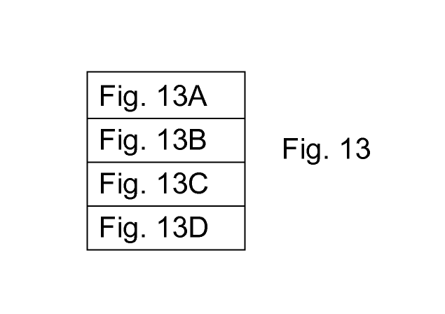

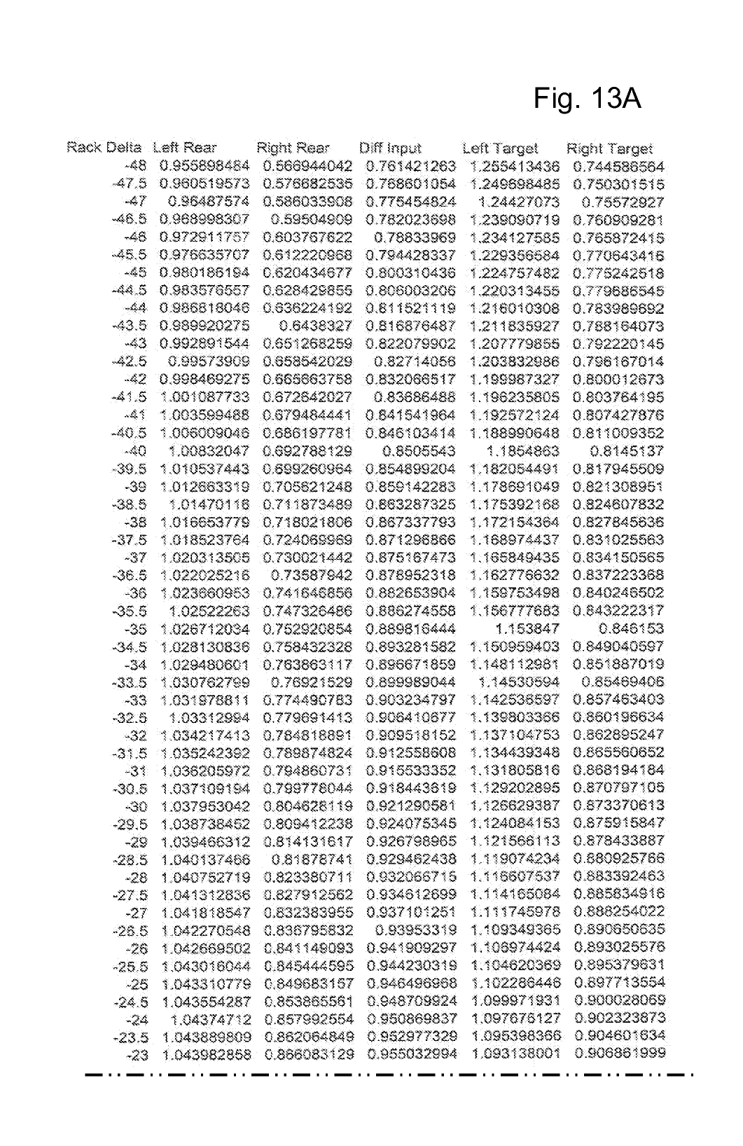

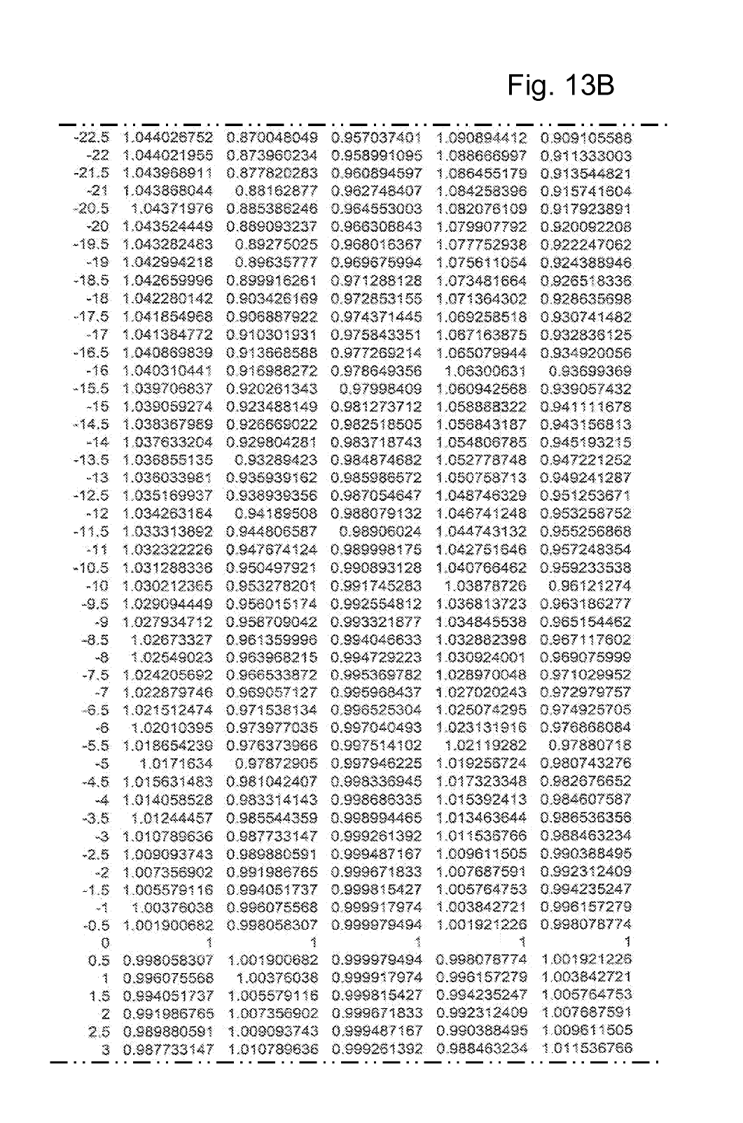

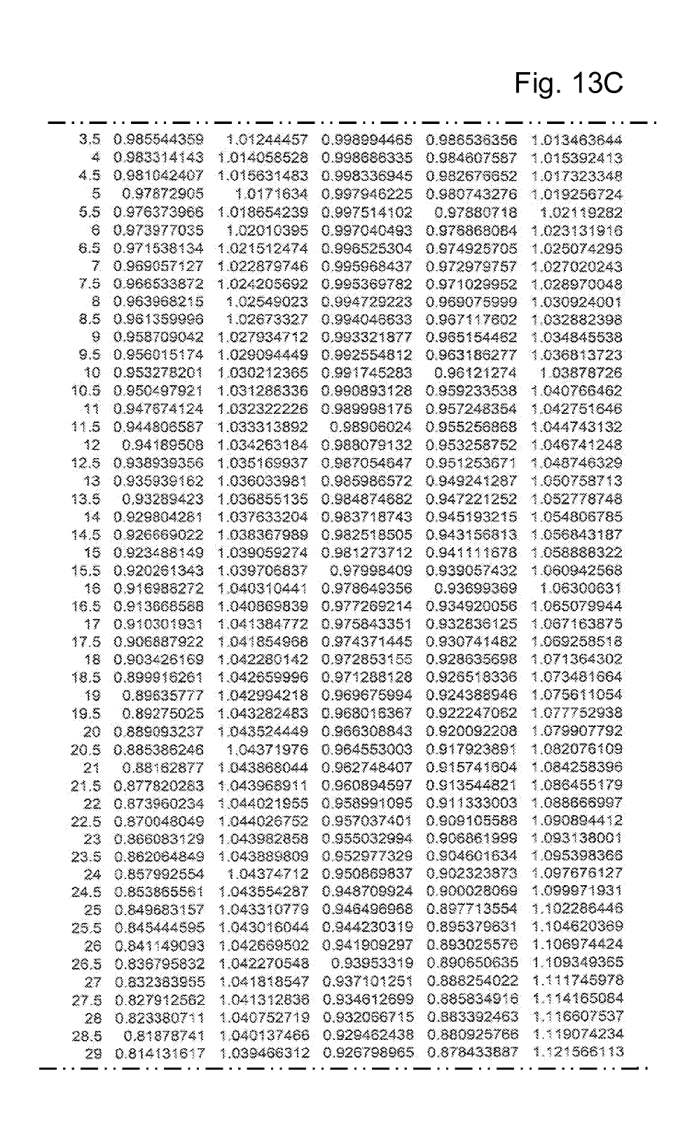

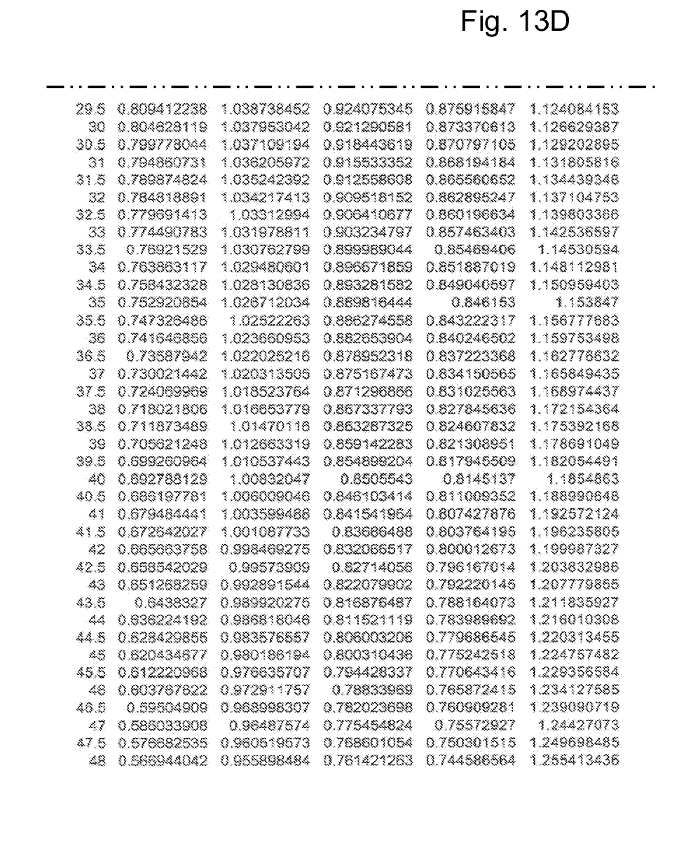

In one embodiment, the data that may be used to implement the differential steering and traction control system are shown in the spread sheet labeled as FIG. 13. This data provides the steering rack deflection in column one and the original drive wheel speed ratios in column 2 and 3 for a prototype vehicle. Columns 4-6 contain the ratios used in an additional embodiment. The speed ratios are in terms of the theoretical wheel speeds and the actual speed of the chassis reference point.

In FIG. 13, column 4 is the ratio of the “differential” input speed to the existing chassis reference speed. The product of this ratio and the travel speed command becomes the set point for the vehicle speed control loop. The feed back value for the vehicle speed control loop is (actual “differential” input speed)=0.5×(actual left wheel speed)+0.5×(actual right wheel speed). In theory this loop controls total torque, or the torque value can be scaled to half of the total and applied to both of the wheel motors since they deliver equal torques until traction control overrides the torque command. Target speeds for the rear wheels are then calculated by multiplying the (actual “differential” input speed) by the appropriate target ratio from column 5 or 6. This target speed is the basis for implementing “Pseudo Braking” when a wheel loses traction. The tables in FIG. 13 allow no over speed because it is necessary to tune both the allowable over speed and the gain of the traction control loops as discussed below. Once the over speed margin is established, the target speed tables to be loaded into the chassis control may be modified to include this margin.

In one embodiment, the chassis controller may implement the basic speed control and determine the speed targets for both motors. The controller will provide the torque setting and speed target to each motor controller. The motor controllers will run in torque control mode unless the target speed is exceeded by n% in which case the torque will be reduced by m% for each additional 1% over speed.

In one embodiment, based on rolling radius measurements of a prototype mowing vehicle, n=about 3% and m=about 15%. This allows driving the vehicle in pure torque control mode until one wheel spins or encounters a severe side slope. However, both of these values may be varied for different vehicles or different performance characteristics.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A differential steering and traction control system for a riding mower with electric motor wheel drives, a steering wheel, and a steered wheel, comprising:
a steer motor sensor for sensing the angular position of the steered wheel;
a wheel speed sensor for each electric motor wheel drive;
a steering wheel position sensor for sensing the rotational position of the steering wheel; a foot pedal providing operator speed commands; and
an electronic control unit receiving the operator speed commands and sensor inputs from the steer motor sensor, wheel speed sensors and steering wheel position; providing commands to the steer motor in proportion to steering wheel position; and providing speed and torque commands to each of the electric motor wheel drives from the operator speed commands, the sensor inputs, and a three dimensional map based on the geometry of the riding mower.

2. The differential steering and traction control system of claim 1 further comprising a torque sensor for each electric motor wheel drive.

3. The differential steering and traction control system of claim 1 wherein the electronic control unit calculates a weighted average speed of the electric motor wheel drives.

4. The differential steering and traction control system of claim 3 wherein the electronic control unit reduce torque to an electric motor wheel drive in proportion to an overspeed ratio of one of the electric motor drives compared to the weighted average speed of the electric motor wheel drives.

5. The differential steering and traction control system of claim 4 wherein the reduction in torque is the product of the overspeed ratio and a gain factor.

6. The differential steering and traction control system of claim 1 wherein the electronic control unit calculates a target speed for each electric motor wheel drive as a function of the weighted average speed of the electric motor wheel drives and the angular position of the steered wheel.

7. A method for providing differential steering and traction control commands to a steered wheel and drive wheels on a riding mower operated with a pedal and a steering wheel, comprising:
sensing the angular position of the steered wheel;
sensing the wheel speed of each drive wheel;
sensing the rotational position of the steering wheel;
sensing operator speed commands from the pedal;
providing steering commands to the steer wheel in proportion to the rotational position of the steering wheel; and
providing speed and torque commands to each drive wheel from the operator speed commands, the angular position of the steered wheel, and a three dimensional map based on the geometry of the riding mower.

8. The method of claim 7 further comprising determining a weighted average speed of the drive wheels from the wheel speed of each drive wheel.

9. The method of claim 8 further comprising determining the target speed for each drive wheel from the weighted average speed and the angular position of the steered wheel.

10. A differential steering system for a riding mower with electric motor wheel drives and a steered wheel, comprising:
a steer motor sensor for sensing the angular position of the steered wheel;
a foot pedal providing operator speed commands; and
an electronic control unit receiving the operator speed commands from the foot pedal and sensor input from the steer motor sensor; and providing speed commands to each of the electric motor wheel drives based on the operator speed commands, sensor input, and geometry of the riding mower.

11. The differential steering system of claim 10 wherein the electronic control unit provides torque commands to each electric motor wheel drive.

12. The differential steering system of claim 11 further comprising measuring torque at each electric motor wheel drive.

13. A method for steering a riding mower having a steering wheel, a steered wheel, and a pair of traction drive wheels, comprising:
sensing the position of the steering wheel, the angular position of a steer motor for the steered wheel, and the speed of an electric wheel motor for each traction drive wheel;
providing speed commands to the electric wheel motor for each traction drive wheel;
providing steer motor commands to the steered wheel;
the speed commands and steer motor commands based on the sensed positions and speeds of the steered wheel and traction drive wheels, and based on stored values for vehicle geometry including a wheelbase, wheel track and tire radius of the riding mower.

14. The method of claim 13 further comprising providing torque commands to each traction drive wheel.

15. The method of claim 13 further comprising calculating the weighted average speed of the traction drive wheels, and calculating the target speed for each traction drive wheel based on the weighted average wheel speed and the angular position of the steer motor.

16. The method of claim 15 further comprising reducing torque to one of the traction drive wheels based on an overspeed ratio of the speed of that traction drive wheel compared to the weighted average wheel speed.

17. The method of claim 16 further comprising reducing torque to one of the traction drive wheels based on the product of the overspeed ration and a gain factor.

18. The method of claim 16 further comprising reducing torque to one of the traction drive wheel using a proportional integral derivative control loop.
